(19) United States
(12) Patent Application Publication
(10) Pub. No.: US 2021/0212880 A1
(43) Pub. Date: Jul. 15, 2021

(54) CRUTCH AND SITTING DEVICE

(71) Applicant: Nami Khademhosseini, Falls Church, VA (US)

(72) Inventor: Nami Khademhosseini, Falls Church, VA (US)

(21) Appl. No.: 16/405,980

(22) Filed: May 7, 2019

(51) Int. Cl. A61H 3/02

(52) U.S. Cl. CPC A61H 3/02; A61H 2003/006

(57) ABSTRACT

A device for Crutches and Sitting Device as an improvement of the basic crutch to provide needed support to ameliorate potential injuries and improve ambulation for persons suffering from injured lower limbs, lumbar region or other injuries, and who frequently require using crutches for mobility. Normally, the conventional crutches require more energy from the user than merely walking, and frequently, a crutch user may require rest. Prior crutch systems have not provided a convenient way to provide the user with such rest. Also, we show crutch support in sitting position that works as a simple and handy decompression system for herniated or bulged discs and injured/weak back muscles. An integrated crutch and walker system is described

### CROSS REFERENCE TO RELATED APPLICATION

This application is CIP of application Ser. No. 15/849,631 filed on Apr. 17, 2019, which is a CIP of application Ser. No. 14/641,313, filed on Mar. 7, 2015. We claim priority on the above filing date. We incorporate by reference all the teachings of the above applications in this application.

### BACKGROUND OF THE INVENTION

Reduced or inhibited mobility presents a significant problem for many people. Whether it is an injury to the leg, hip, wrist, lumbar, or the result of increased age, mechanical devices are often used for assisting the user to enhance their mobility. Canes, crutches, walking sticks and various other devices have been in use for a considerable time. However, the functional design of these devices has remained substantially the same. Unfortunately, for the user, these devices are often cumbersome, uncomfortable, and difficult to use in slippery surface situations and do not support the user's back adequately in the standing or seated position.

Persons suffering from injured lower limbs are frequently required to use crutches for mobility. However, crutches require more energy from the user than merely walking, and frequently, a crutch user may require rest. Prior crutch systems have not provided a convenient way to provide the user with such rest, and correct positioning for wrists, which necessitate support to the back and lower lumbar region. This support is important to the crutch user in both the standing and seated position.

It would also be advantageous for a crutch, or similarly constructed walking aid, to provide greater comfort for the user. It would be further advantageous for the walking aid to utilize the user's energy to mechanically assist the user, while walking. Furthermore, it would be advantageous for a walking aid to provide enhanced grip on slippery and/or uneven surfaces. It also would be advantageous for walking aid to provide an ergonomic handle that provide a correct hand rest and wrist positioning.

While various modifications have been attempted, there is presently no crutch that incorporates the appropriate ergonomic structure in a light-weight, sure gripping, user friendly, shock absorbing, ergonomic handle, and collapsible format. Now, we introduce different embodiments of our inventions:

The current invention, Crutches and Sitting Devices, is designed to ameliorate many health problems caused and exacerbated by the classic crutch design and provide the light-weight, sure gripping, user friendly, shock absorbing, ergonomic handle, and collapsible format that users need. This current invention is also designed to provide the support to the back a crutch user requires in both the standing and seated positions.

The injuries resulting from the traditional crutch use are in part due to the fact that patients overly rely upon the underarm portion to support the body weight. The invention here is designed to take considerable pressure from the underarm portion and support the body weight of the user ergonomically. This crutch is designed for the contour of the shape of the axilla. This minimizes potential underarm nerve injuries, like neuropraxia, and even complete paralysis of the arm. The design also ensures that the pressing weight of the body is not solely directly on the axilla, thus, minimizing the occurrence of muscle strain of the arms and shoulders, as well as joint pain to the shoulders.

Additionally, this improved crutch design minimizes and reduces injuries to the hand and wrist. The hand grip is contoured to fit a patient's palm, designed to maintain the hand and wrist in a neutral position, when the crutches are in use or at a e.g. 5 to 25 degree angle during ambulation. The general construction and design of existing crutch hand grips does not provide the correct ergonomic orientation between the wrist and forearm, even though padding may be present. Failure to achieve correct alignment and padding in the palmar area can result in disorders of wear and tear, including overuse syndromes, repetitive strain injuries, musculoskeletal injuries, and compressive neuropathies. Common injuries resulting in such usage include: carpal tunnel syndrome, wrist tendonitis, medial or lateral elbow epicondylitis, and rotator cuff muscle strains and tears. These disorders appear to be more common in the chronic crutch user, and are the result of repeated stresses on a particular musculoskeletal area. Thus, none of the traditional crutch constructions effectively support the users' body weight or torso in a comfortable manner so that they are able to walk using minimal energy with maximal comfort.

The following prior art references describe adjustable crutches, ergonomic cushions and had grips and curved crutch tips. These prior art, attempt to, but do not comprehensively solve the issues described above, and nor do these crutches provide ergonomic back support and spine decompression to a user who is seated. Further, these adjustable feature of the prior art are generally to support storage the crutch after use. However, the adjustability of ours facilitates a shorter support embodiment to support the user, while seated.

No other prior art has solved these problems this way and this efficiently.

Embodiments of the present invention generally relate to an orthopedic device to improve mobility and orthopedic support, while seated. More specifically, various embodiments of the present invention relate to multi-stage collapsible crutches that supports while both standing and seated.

Some of the prior art for the adjustable crutches are (which are listed in IDS, as well):

U.S. Pat. No. 8,844,548 teaches a walking aid support which includes an embodiment that comprises an oval shaped bottom and a downwardly angled slit. This support is configured facilitating walking and providing support in rough terrain.

U.S. Pat. No. 8,800,579 teaches an adjustable crutch designed to address three documented hazards or situations that may cause the crutch user to fall and injure themselves, however, it does not teach the support and amelioration of injuries to the underarm and hand, nor does it support the seated user.

U.S. Pat. No. 8,474,470 teaches an adjustable crutch designed to support an infirmed person's weight, while standing, but does not support the person's weight, while seated.

U.S. Pat. No. 8,418,704 teaches a power adjustable crutch assembly for assisting a user in transitioning between a seated position and a standing position. The assembly includes a support configured for positioning under an arm of a user. An upper frame is coupled to and extends downwardly from the support. A lower frame is in slide form coupled to the upper frame. An adjustment assembly is operationally coupled to the lower frame and the upper frame. It does not claim support for the user while seated, and as with most adjustable crutches, the adjustable characteristic is for ease of storage and/or usage in the standing position, not to support while seated.

U.S. Pat. No. 5,465,745, an adjustable crutch, includes upper and lower assemblies which are in slide format interconnected with one another and constructed of hollow aluminum pipes, or tubing, interconnected by glass or fiber-reinforced nylon members. The present invention has significantly more features to ensure the safety of the user and the three sliding members per staff allows the crutch to support the user in the seated position.

U.S. Pat. No. 7,360,547 is for a walking assist device which includes an elongate shaft having an adjustable length, a handle detachably connected to a proximal end of the elongate shaft, and a curved elongate base that mate to and engages a distal end of the elongate shaft.

U.S. Pat. No. 7,537,017 teaches a shoulder support assembly for an adjustable crutch. The shoulder support assembly is goaled to solve many of the health issues connected to the usage of the standard crutch, but does provide adequate support, and it lacks the obvious advantages of a standard adjustable crutch.

Deficiencies of the embodiments in these prior art references documented above are their lack of ability to balance mobility, walking steadiness, support the back while seated, and prevent tripping.

US Patent Application 2013/0263901 teaches a handgrip for a crutch that, unlike the claimed design, is offset from the plane of the crutch in both forward and rear end of the grip.

U.S. Pat. No. 8,776,321 teaches an ergonomic hand grip that provides shock absorption and reduces fatigue. More specifically, the present technology is a hand grip of varying thickness to permit support, while also absorbing shock and vibration.

U.S. Pat. No. 8,950,415 teaches a crutch system pertaining to assembly and disassembly purposes, and the assembly and the disassembly of the crutch system adapted to be done in a simple, safe, rapid and economical manner. As with crutches analysis, the detachable claim is related to ease of assembly, and not support the user while seated.

So, no other prior art has solved these problems this way and this efficiently, as described in our inventions below.

### SUMMARY OF THE INVENTION

In one embodiment, we describe a method and a device as an improvement for the traditional crutch and its usage. More embodiments are given below: The current invention has the design and function that far exceeds those of a traditional crutch/walking/sitting aid. It deals particularly with a more comfortable construction in crutch design. This invention is designed to provide help and relief for more effective ambulation and improved posture, for disabled as well as pre- and post-operative population, e.g., patients with chronic herniated or bulging discs.

The present invention provides for a crutch base that addresses three hazards of the typical crutch:

1) losing balance on a slippery surface caused by the tip sliding out from underneath the person;

2) hitting an object or an obstacle on the ground with the walker causing the person to continue in motion through inertia, while the walker is stopped by the obstacle; and

3) being restricted by the walker as the person moves forward or slips backward as he/she grabs onto the walker for support, but the walker is insufficiently flexible to move with the person.

A first embodiment of the present invention is configured for persons with a relatively severe handicap and limited moving dexterity, generally unable to walk without a walking aid. This embodiment is configured for providing stability in bumpy or slippery walking terrains under a number of adverse situations that may occur. A second embodiment of the present invention is configured for use by persons who are not severely handicapped and use a walking aid, possibly for optional support, if, for example, one leg is sore or injured. Such a person would desire flexibility and only minimum movement restriction from the use of the walking aid.

The invention is also adjustable and allows the user to support his/her body weight in the seated position. This allows for more effective rest and reduces stress on the lumbar region. This is important and distinguishes this invention from the prior art. Using this design in the seated position elevates the upper body such that the user's upper body weight does add significant pressures to the lower back and spine. Thus, elevating and elongating the upper body reduces the pressure and stress to the lower body reducing the possibility of injury or worsening injuries, such as herniated discs and bulging discs, by decompressing the spine and alleviate upper body weight pressure on injured discs. The lower back is vulnerable to body weight pressures, while standing and seated, and this design minimizes those harmful pressures. This design also effectively supports the user's body weight/torso in a comfortable standing position so that the user is able to walk using minimal energy with maximal comfort.

In addition to supporting the user in ambulation and in the seated position, the design of the underarm cushion reduces stress and injury. This crutch cushion is designed to contour to shape of the axilla. The combination of the cushion form and special soft memory foam used in it minimizes potential underarm nerve injuries like neuropraxia, and even complete paralysis of the arm. The design also ensures that the pressing weight of the body is not directly on the axilla, thus minimizing the occurrence of muscle strain of the arms and shoulders, as well as joint pain to the shoulders.

Furthermore, the hand grip is contoured to fit a patient's palm and designed to maintain the hand and wrist in a neutral position when the crutches are in use or at a e.g. 5 to 25 degree angle during ambulation. The general construction and design of existing crutch hand grips does not provide the correct ergonomic orientation between the wrist and forearm, even though padding may be present. Failure to achieve correct alignment and padding in the palmar area can result in disorders of wear and tear, including overuse syndromes, repetitive strain injuries, musculoskeletal injuries, and compressive neuropathies. Common injuries resulting from such usage include: carpal tunnel syndrome, wrist tendonitis, medial or lateral elbow epicondylitis, and rotator cuff muscle strains and tears. These disorders appear to be more common in the chronic crutch user, and are the result of repeated stresses on a particular musculoskeletal area. Thus, this improved crutch design reduces injuries in ambulation, injuries to the hand through improved handgrips, and injures of the axilla, due to breathable gel and foam cushioning, and provides the user support and rest, while using the crutch, while seated.

### BRIEF DESCRIPTION OF THE DRAWINGS

FIG. 1 shows a side view of the adjustable crutch.

FIG. 2 shows a frontal elevation view of the adjustable crutch.

FIG. 3 shows a side elevation view of the adjustable crutch. The side view shows a human holding the hand grip and being supported in standing position.

FIG. 4 shows a roughly 45 Degree angled elevation side view of the adjustable crutch, used by a human in the seated position. The view shows the use of the crutch adjusted to be used to support a seated human.

FIG. 5 shows a side cross section view of the cushion of the crutch.

FIG. 6 shows a side cross section view of the rivets that are used to secure the crutch's replaceable cover on the cushion. It can be used as an alternative to snap button for attachment/detachment the cushion cover to the under arm cushion.

FIG. 7 shows a side view of the handgrip as it is connected to the crutch.

FIG. 8 shows a top view of the handgrip.

FIG. 9 shows a top cross sectional view of the wrap around snap system locking the handgrip from outside of the upright support, inlayed in the handgrip.

FIG. 10 shows a top cross sectional view of the wrap around snap located in the conjunction of each two segments of the crutch shaft.

FIG. 11 shows a side view of the elastic bottom part.

FIG. 12 shows a side view of the handle with larger front bracket (1001) and back bracket (1002), which secure the handle attachment to the upright supports/crutch shafts or bars.

FIG. 13 shows the rod through the upright support holes, to fasten handle, by new bolt to the supports. This is a very different handle with respect to the prior art, in which the top view looks like a rectangle with parallel connections to the support poles.

FIG. 14 shows how the rod passes through the handle and both brackets.

FIG. 15 shows rod 2001 and bolt 2002.

FIG. 16 shows the handle 2003 with attachments and components. It shows a different handle. This handle is designed to be closer to the rod axis with a slight angle to the axis.

FIG. 17 shows a bolt 2002 that can be twisted at the end of the rod, either by fingers (thumb and point finger), using the curved sides, or by using screw driver, by inserting it into the slot (opening) in the middle.

FIG. 18 shows a bolt 2002 that can be twisted at the end of the rod, either by fingers (thumb and point finger), using the curved sides, or by using screw driver, by inserting it into the slot (opening) in the middle.

FIG. 19 shows the use of the locks to secure handle on the supports: open 3002 and closed 3001 positions.

FIG. 20 shows a new feature/function that uses two concaved tabs (3004) for two-finger placement, that can be pushed together, and as they squeeze the spring (3003), they pull both locking pins (3005) to the center, therefore, releasing the handle system from the upright supports for position adjustment.

FIG. 21 shows a new cushion which comprises of a top layer of gel infused memory foam 4002 (for cooling under arm, while in use), plus air capsule/balloon/bubble or bouncy materials 4001, plus (highly) bouncy/elastic material(s) 4003.

FIG. 22 shows swinging design for cushion. The crutch middle is swing at the pivot point 4004, where it is affixed to the curved support 4006, with springs 4005.

FIG. 23 shows a different form of the underarm cushion, which is moved more to the back of the crutch and is shorter in the front, plus the snap buttons that can be used, instead of rivet (5001).

FIG. 24 shows under the underarm structure: the male part of the snap buttons are affixed under the structure.

FIG. 25 shows a replaceable/washable cover (5001) plus the female part of the snap button, facing inside of the cover. Female part (5002) of the cover snap on the male part, affixed under the underarm cushion, to secure the washable cover over the cushion (5003).

FIG. 26 shows the hollow spaces (6002) that functions as shock absorbent of the base, with spring (6001).

FIG. 27 shows the anti-slip/slide thread design, specifically made for the crutch, which has maximum traction power on the ground, to help stabilize the ambulation, especially in case of inclement weather, e.g., with slippery/icy/frosty/mud/sleet ground conditions.

FIG. 28 shows the pressed point 6003 that provides secure attachment of the underarm structure and base (from FIG. 29) to the upright supports/pipes/poles.

FIG. 29 shows the pressed point that provides secure attachment of the underarm structure (from FIG. 28) and base to the upright supports/pipes/poles.

FIG. 30 shows a two-part detachable crutch with special ergonomic handle and cushion that sits/positioned toward the rear.

FIG. 31 shows a different design that has a curve in top part/segment of the crutch to provide more space between two crutches around the waist area for people with large/wide hip (7002).

FIG. 32 shows two small caps 7001 which can be used after detaching the top part to prevent the bottom end pipes from piercing/denting the sitting surfaces.

FIG. 33 shows a totally detachable crutch (with two pieces of top and bottom): top part only in use in sitting position, to stretch the upper body or decompression of back/spine.

FIG. 34 shows a mold for creating an alternative embodiment of the handle.

FIG. 35 shows a front perspective view of the handle of FIG. 34.

FIG. 36 shows a rear perspective view of the handle of FIG. 34.

FIG. 37 shows an alternative embodiment of a cane formed in accordance with the invention.

FIG. 38 shows an alternative embodiment of a forearm crutch formed in accordance with the invention.

FIG. 39 shows an alternative embodiment of a rubber tip for a cane formed in accordance with the invention.

FIG. 40 shows an alternative embodiment of yet another forearm crutch formed in accordance with the invention.

FIG. 41 shows a walker using a telescoping crutch as a replacement handle in accordance with another aspect of the invention.

FIGS. 42 and 44 show a walker modified using the crutch shown in FIG. 4-7.

FIG. 44 shows the crutch used for modifying the walkers.

FIG. 45 shows a detail of FIG. 44.

FIGS. 46-47 show another crutch embodiment.

FIG. 48 shows the crutch of FIG. 46-47 used with a walker.

FIGS. 49 and 47 show the completed handle of FIGS. 33 and 34.

FIGS. 51A-51H show the handle of FIGS. 49 and 50 from different angles and at various stages of manufacture.

FIG. 52 shows a comparison of user stress using the handle of the invention and a prior art handle.

FIG. 53 shows the handle of the invention positioned on a standard crutch.

### DETAILED DESCRIPTION OF THE PREFERRED EMBODIMENTS

The following detailed description is for various embodiments, as some were explained above, as well. The description is not to be taken in a limiting sense, but is made merely for the purpose of illustrating the general principles of the invention, or as some examples.

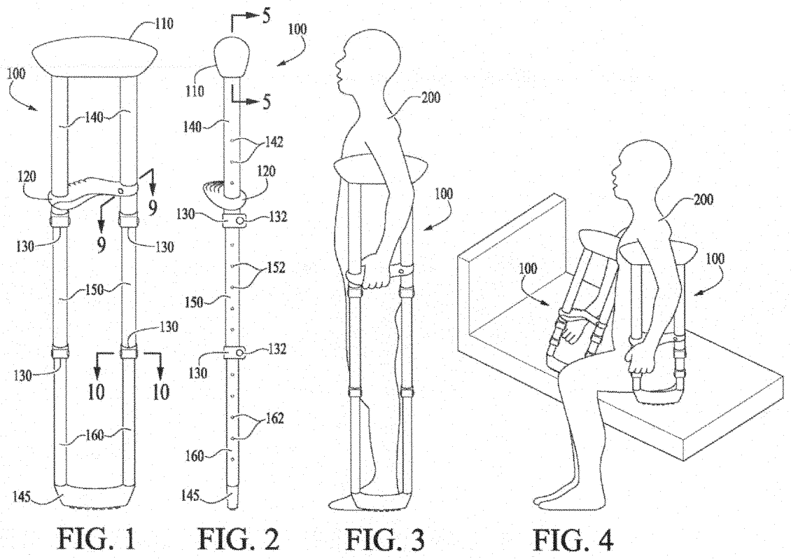

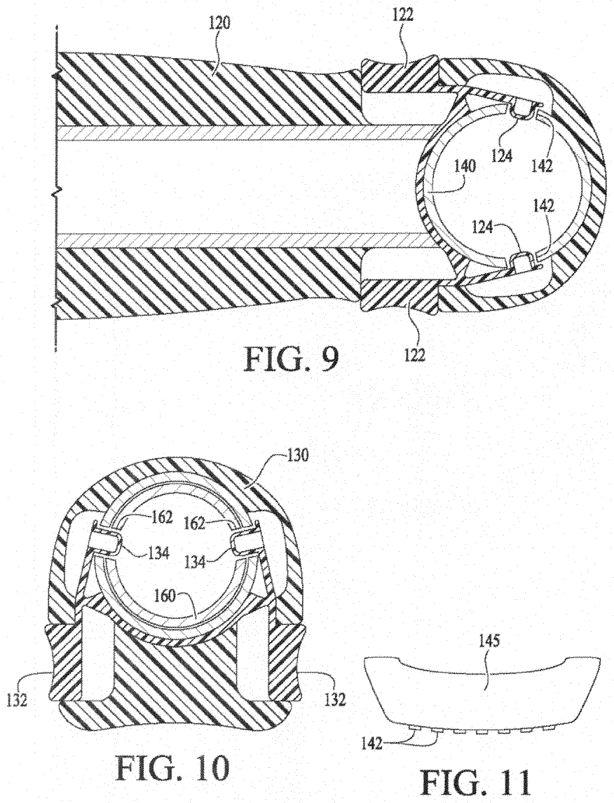

The Design for Crutches and Sitting Devices is an embodiment of a crutch comprising a pair of support shaft members. Each member is comprised of three shafts, 140,150 and 160. FIGS. 1 and 3 show supporting member 140, the top member of the support shaft, while supporting members 150 and 160 are also shown in FIGS. 1 and 2, which are the middle and bottom members, comprising the support staff Each supporting element of the crutch, 140, 150, and 160, is designed to maintain the telescoping adjustable character and is of different internal and external diameters. Each support staff includes a plurality of adjustment holes shown in FIG. 2, as 142, 152 and 162. These adjustment holes receive the wrap around snap, as in FIGS. 9 and 10, which secures the members in place and prohibits for the members from sliding in a telescoping manner, which facilitates the adjustability of the crutches. The supporting elements may be fabricated of metal, such as steel aluminum, steel, and titanium, or another appropriate material, and are formed in a generally hollow cylindrical shape.

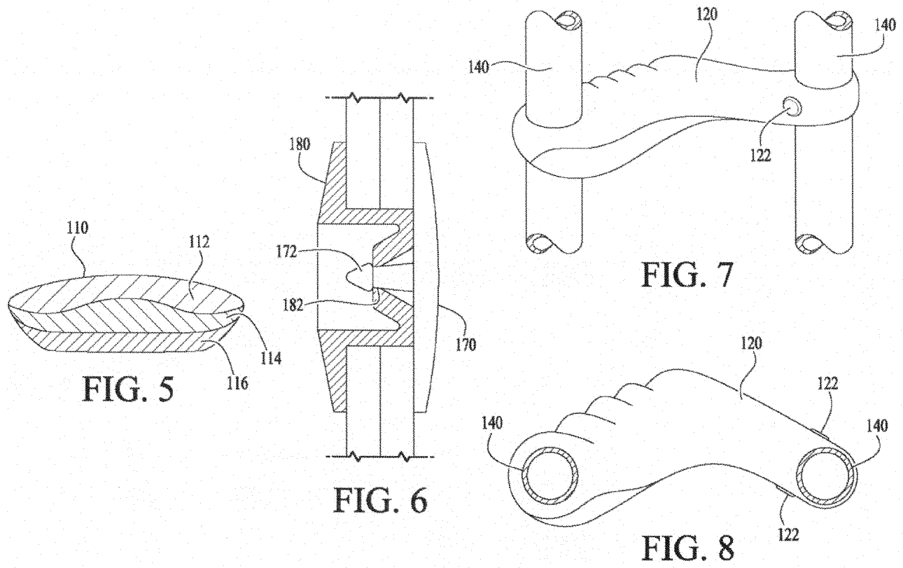

The underarm support crutch cushion is shown on FIG. 5, plus element 110 on FIG. 1, located toward the proximal end of the support shaft member, shown as 140, in FIG. 1, and it is comprised of gel infused memory foam (open cell) cushion top layer of the underarm cushion, to absorb jarring motions of ambulation, creating a more even and more comfortable ambulation.

Another embodiment of this invention is directed to a method of making a composite material of the underarm support crutch cushion, comprising: providing a layer of foam material.

The cushioning article or element, as illustrated in FIGS. 1 and 5, may also comprise a barrier layer of thermoplastic polyurethane (TPU) as the middle layer 114 of the cushion (with 116, as the solid base/cradle for supporting 2 upper layers).

In addition to the under arm support cushion, a trapezoidal shaped bottom element 145, FIG. 1, and shown in details in FIG. 11, may be used at the distal end of support shaft element 160. The trapezoidal bottom is designed to assist in ambulating over uneven surfaces and to provide a cushioning effect. The trapezoidal shaped tip, connected to both the front and rear end of the crutch, provides appropriate friction between the crutch 100 and the walking environment. The trapezoidal curved shape of the base of the crutches provides a smoother, more even mode of ambulation, which is more natural and more comfortable for the user.

a. A walking aid support comprising a substantially trapezoidal bottom for engaging a walking ground; and

b. A pattern of “treads” or grooved patterns at the bottom of the trapezoidal base. The elastic base is made of a combination of softer (53 A Shore) and harder plastic (75 A Shore), which can provide a more solid grip on different surfaces, such as slippery ice, water, or uneven surfaces; and

c. The acute angle of the base is between about 0 degrees (at the midpoint of the base) and about 45 degrees (as it reaches each of the structural tubes).

The hand grip 120 has the appropriate contours and ergonomic angulation to fit the palm and align the wrist. The hand grip 120 is shown in details in FIGS. 7 and 8. FIG. 8 shows that hand grip 120 has an angled offset from the rear in the range of 0.5″ to 3.0″. There is no offset distance from the forward tube, and the handgrip has a triangular shape. The angle of the handgrip device, shown in FIG. 7, due to the difference between the back and front end vertical positioning, is between 5 and 25 degrees down from rear to front, as just examples, but not limiting the teachings here, as is the case for other numbers in the disclosure, as examples only.

The handgrip device, FIG. 8, is made or encased in a molded ergonomic grip shape for improved weight distribution.

a. The present crutch provides a hand grip that is comprised of two different plastics, e.g., one at 53 A and one at 75 A Shore; and

b. By mixing the pliability of the two different plastics, the grip has the ability to feel “dry” even when wet by perspiration or by weather; and

c. The grip of the crutch has grooves that are perpendicular to the lines of muscular tension, thus allowing for a steadier and stronger grip or grasp, shown clearly in both FIGS. 7 and 8.

As indicated above, the crutch is adjustable and can be secured in various positions that ensure comfort and amelioration of injuries associated with normal use. Once adjusted to the appropriate height for the user, via telescoping effect of the 3 support members, 140, 150, and 160, wrap around snap, 130, will be used to secure the support members in place. Alternative devices may be used as latching mechanisms, instead of the illustrated wrap around snaps. (For example, a single pin with a radial biased outward.)

FIG. 1 shows a side view of the adjustable crutch. FIG. 2 shows a frontal elevation view of the adjustable crutch. FIG. 3 shows a side elevation view of the adjustable crutch. The side view shows a human holding the hand grip and being supported in standing position. FIG. 4 shows a roughly 45 Degree angled elevation side view of the adjustable crutch, used by a human in the seated position. The view shows the use of the crutch adjusted to be used to support a seated human.

FIG. 5 shows a side cross section view of the cushion of the crutch. FIG. 6 shows a side cross section view of the rivets that are used to secure the crutch's replaceable cover on the cushion.

FIG. 7 shows a side view of the handgrip as it is connected to the crutch. FIG. 8 shows a top view of the handgrip.

FIG. 9 shows a top cross sectional view of the wrap around snap inlayed in the handgrip. FIG. 10 shows a top cross sectional view of the wrap around snap located in the conjunction of each two segments of the crutch shaft. FIG. 11 shows a side view of the elastic bottom part.

In one example, we describe a device for Crutches and Sitting Device as an improvement of the basic crutch to provide needed support to ameliorate potential injuries and improve ambulation for persons suffering from injured lower limbs, lumbar region or other injuries, and who frequently require using crutches for mobility. Normally, the conventional crutches require more energy from the user than merely walking, and frequently, a crutch user may require rest. Prior crutch systems have not provided a convenient way to provide the user with such rest. The current invention fulfills at least two functions, as an example of the device or system: (i) providing improved walking aid for those recovering from orthopedic surgery of the spine and lower extremities, as well as those who suffer from permanent disability from the spine and lower limbs; and (ii) improved sitting aid for those recovering from orthopedic surgery of the spine and lower extremities, as well as those who suffer from permanent disability of the spine and lower limbs, such as people with chronic herniated or bulged disc in their spine, as examples. Many other different variations are shown here, as well.

Other embodiments: The present invention has for its primary object to provide a more comfortable and supportive mode of ambulation using an upgraded version of the traditional crutch, which can easily be converted into a sitting aid. When compared to current crutch designs, the present invention offers a number of improvements, as mentioned above.

Other embodiments: An adjustable crutch to aid mobility of a user in moving over various walking surfaces and support the user in the seated position. The adjustable crutch comprises: (a) two telescoping shaft elements each comprised of three tubes, an upper, middle, and bottom tube, each of which is configured to slide in the adjacent lower tube to adjust the height of the crutch; (b) a hand grip element at the distal end of the upper tube. The hand grip is configured for the user to grasp to support the weight of the user; (c) a cushion configured to fit beneath an underarm of the person. The cushion being attached to proximate ends of the upper tubes; and (d) a crutch bottom or tip assembly, configured to engage the walking surface, when the person uses the crutches to move over the walking surface, and the crutch bottom being attached to ends of the lower tubes.

The adjustable crutch, wherein each of the pair of lower tubes is configured to slide inside one of the pair of middle tubes and the each pair of middle tubes is configured to slide inside one of the pair of top tubes, thus, ensuring adjustability of the height of the crutch via the telescoping characteristic of the tubes and ensuring that the crutch can facilitate a height consistent with use of the crutch to support the user while seated.

The adjustable crutch, with a more pliable design of the armpit cushion, which will absorb shock incidence, creating a more comfortable and natural mode of ambulation. A more secure and stable support for the users' posture and torso, which is attached directly to the tubular longitudinal structure, creating a more comfortable and less painful mode of ambulation or sitting position.

The adjustable crutch, wherein the upper portion of the under-arm cushion, FIG. 5, consists of a layer of gel-infused open cell memory foam material in direct contact with the cushion cover, extending from the upper surface of the cushion to the middle layer, in which it comprises of a soft and flexible plastic core piece, and the bottom layer. (The solid base, which supports the middle and top layer and is adjacent to the top end of the shafts.)

The cover is removable so that users can clean or replace the cover, as it is vulnerable to under-arm perspiration and other forms of dirt, and the upper portion of the under-arm cushion, which can be removed and cleaned with common anti-bacterial soap/detergent and replaced on top of the middle portion (plus the removable upper portion of the under-arm cushion, attached to the lower portion with embedded protruding metal snaps, or rivets (plus the removable upper portion of the under-arm cushion, which is also disposable (and new cushions can be ordered to replace these items, should the user want to do so))).

The adjustable crutch, with a more secure and stable support for the user's posture which is attached directly to the tubular longitudinal structure, creating a more comfortable and less painful mode of ambulation or sitting. The support comprises a dual, parallel design of the supporting poles, providing more consistent and reliable ambulatory motion; a locking, wrap-around snap which includes pins that can be inserted into the openings, as shown in FIGS. 9 and 10, and snap into place for the positioning of the overall height of the crutch (for walking or as adjusted for sitting); and the length of distance from the under-arm cushion to the handgrip of the crutch; and the distance of the handgrip to the ground, which can be adjusted as a walking aid or as a sitting aid.

The adjustable crutch, wherein the crutch has two support poles extending from the top of the crutch downward toward the ground, comprising: a handgrip element, for handgrip device for an ambulation assistance; one handgrip element support pole attachment mechanism for each pole bridged by the handgrip element, wherein the attachment mechanisms are user installable and removable, and provide a support for the handgrip element spaced outboard from the plane of the poles away from the body side of the crutch by an offset distance. There is no offset distance from the forward tube (thumb end) end of the handgrip, while there is the offset distance from the rear tube, when installed on the crutch.

a. The handgrip device, wherein the offset distance from the rear tube is in the range of 0.5″ to 3″, or from 5 degrees to 25 degrees, as only examples, to maintain a stress-neutral position; and the vertical positioning of the forward end of the handgrip is lower to the ground from then the back end vertical positioning of the handgrip; and the handgrip is curved outward relative to the plane of the support poles.

The adjustable crutch, wherein the handgrip device offset distance from the rear tube is 0.5″ to 3″ (inches), or from 5 to 25 degrees, to maintain a stress-neutral position; the handgrip, wherein the angle of the handgrip element due to the difference between the back and front end vertical positioning is between 5 and 25 degrees down from rear to front. The handgrip device is at least one made or encased in a molded ergonomic grip shape for improved weight distribution. The hand grip is comprised of two different plastics, one at 53 A and one at 75 A Shore, which by mixing the pliability of the two different plastics, the grip has the ability to feel “dry” even when wet by perspiration or by weather. And the grip of the crutch has grooves that are perpendicular to the lines of muscular tension, thus allowing for a steadier and stronger grip or grasp. The grip also can have a core solid support across the upright supports (Appendix 3-2 metal core piece), which bears the weight of the user hand. The solid core piece is over-molded by elastic soft material to provide comfortable and safe grip.

The adjustable crutch, with a trapezoidal or curved shape of the base of the crutches, to provide a smoother, more even mode of ambulation, which is more natural and more comfortable for the user; a pattern of “treads” or grooved patterns in the bottom of the trapezoidal or curved base, made of a combination of softer (53 A Shore) and harder plastic (75 A Shore), which can provide a more solid grip on different surfaces, such as slippery ice, water, or uneven surfaces; and the acute angle of the base is between about 0 degrees (at the midpoint of the base) and about 45 degrees (as it reaches each of the structural tubes).

The following Items are shown in various figures, i.e., FIGS. 1-11:

Item 112 (right side curvature on top of underarm support crutch cushion, or item 110 in e.g. FIG. 5), 114 (left side curvature on top of underarm support crutch cushion), 116 (bottom side of underarm support crutch cushion), 170 (the disc behind the pin, as the end of the pin), 172 (pin head for connection, to hold the parts together, as shown in FIG. 6), 182 (the hole that pin head goes through, to hold the parts together, as shown in FIG. 6), 180 (the assembly where the pin is attached to, to hold the parts together, as shown in FIG. 6), 122 (spring loaded pin, coming out of the tube, from the other side, to adjust the height and hold the sections as one piece, as shown in FIG. 7), 124 (the extension pins, coming out toward the center of circle cross section, for the opening hollow section along the vertical rod 140 in FIG. 2, to attach rod 140 to the body of the handgrip, as shown in FIG. 9), 140 (vertical rod/upright pipe/support, as a section of the vertical parts of the crutch, located along the length or height of the crutch, as shown in FIG. 1 or FIG. 2), 142 (the opening on the circumference of the circle cross section, which engages with item 124, to get fitted with item 124, and to hold the vertical rod 140 (as part of the crutch shaft) stationary with respect to the body of the handgrip or item 120 (as the middle section of the handgrip), as shown in FIG. 9), 130 (wrap around snap's body, shown in FIG. 10 or FIG. 1), 145 (bottom section of the crutch, shown in FIGS. 1, 2, and 11), 132 (buttons on the side of wrap around snap, item 130, in FIG. 10), 134 (the extension pins, coming out toward the center of circle cross section, for the opening hollow section along the vertical rod, e.g., item 160 in FIG. 1, to attach rod 160 to another rod, as a part of the crutch shaft, e.g., item 150 in FIG. 1, with the horizontal cross section as shown in FIG. 10), 160 (a vertical rod, as a part or section of the crutch shaft), 162 (the opening on the circumference of the circle cross section, which engages with item 134, to get fitted with item 134, and to hold the vertical rod 160 (as part of the crutch shaft) stationary with respect to another vertical rod (as part of the crutch shaft), e.g., item 150 (as part of the crutch shaft), as shown in FIG. 10 or FIG. 1), 142 (the small dots at the bottom of item 145, i.e., the bottom section of the crutch, shown in FIGS. 1, 2, and 11, for better grip and less slipping/accidents), and 200 (a typical human/user, with hand, shoulder, and arm grabbing the crutch at different locations as shown in FIGS. 3-4).

For vertical parts of the crutch, or crutch shaft, we have multiple sections or parts or rods, which are connected together, as shown in FIGS. 1-4. The parts or rods are called with different names across this disclosure, e.g., as “shaft”, “supporting member”, “supporting element”, “supporting staff”, “supporting shaft member”, or “support shaft element”. However, all refer to the same thing, i.e., as pieces or sections or parts or elements or members of the crutch shaft, in vertical direction, as a shaft or bar which supports the weight of a person or user along the crutch, in vertical direction, as shown in FIGS. 1-4. Thus, all phrases above are interchangeably used in the disclosure.

The adjustable crutch, which comprises a more secure, wrap-around locking snaps that allow adjustments from a walking crutch to an aid for sitting or getting out of a chair, with crutch comprising a bottom portion, a top portion, and a middle portion, and wherein wrap around snaps are used to secure the shaft element to one another and lock them in the height that they are adjusted to.

Wrap around snap comprises of two push buttons in which engage or disengage the pins which lock or unlock the telescoping shafts.

Appendix 1, pages 1-5, have many variations of our inventions shown in FIGS. 1-11, above. Appendix 2, pages 1-5, show the variations and details of the handle for this invention, as some embodiments.

One example of usage/advantage: According to some medical research and publications, e.g., from the Internet sources, the nonsurgical spinal decompression is a type of motorized traction system that may help relieve back pain. Spinal decompression works by gently stretching the spine. That changes the force and position of the spine. This change takes pressure off the spinal disks, which are gel-like cushions between the bones in your spine, by creating negative pressure in the disc. As a result, bulging or herniated disks may retract, taking pressure off nerves and other structures in the spine. This in turn, helps promote movement of water, oxygen, and nutrient-rich fluids into the disks so they can heal. So, our crutch can have a very positive effect on this healing process and recovery, as an example.

In addition, the correct alignment of the hand, wrist, and arm, with respect to the handle is very important, as the correct orientation prevents injury to the wrist and hand of the user. Our handle design and orientation with correct alignment for the hand, wrist, and arm are shown in various Figs. of Appendix 2, pages 1-5.

So, there are many advantages for our inventions, including, e.g.: 1) releasing/reducing pain by spinal decompression in sitting position, and 2) preventing side effect of wrist pain for crutch users.

One of the features of this invention is the unique handle it has, which helps the user or patient for recovery and avoiding any injury.

In one embodiment, we have a cushion top for the handle.

In one embodiment, we have a spring-action for the handle.

In one embodiment, we have a saddle shape, as shown in the figures/appendices.

In one embodiment, we have a rocking-action for the under-arm support.

In one embodiment, we have pointer finger and thumb are supported by the handle properly, which is a big advantage over the prior art. In one embodiment, as shown in FIG. 16, we have a novel handle for the best grip position, with the left side of the Fig. is pointing toward the front of the user (the front side of the handle). The front side of the handle is closer to the shaft (or the vertical bar/support for the crutch) than the opposite/back side of the handle, which is placed at a larger distance from the other shaft of the crutch (e.g., based on the average distance, or center-of-mass distance to the shaft, for each piece or portion), as shown in FIG. 16.

The cross section of the handle shown in FIG. 16 is also very different from that of the prior art, which is rectangular in shape, and comes out from front and back sides. Generally, the conventional crutch grip causes pain in the hand/wrist/muscles/skeleton. So, our inventions are very helpful to avoid the damage and pain for the user.

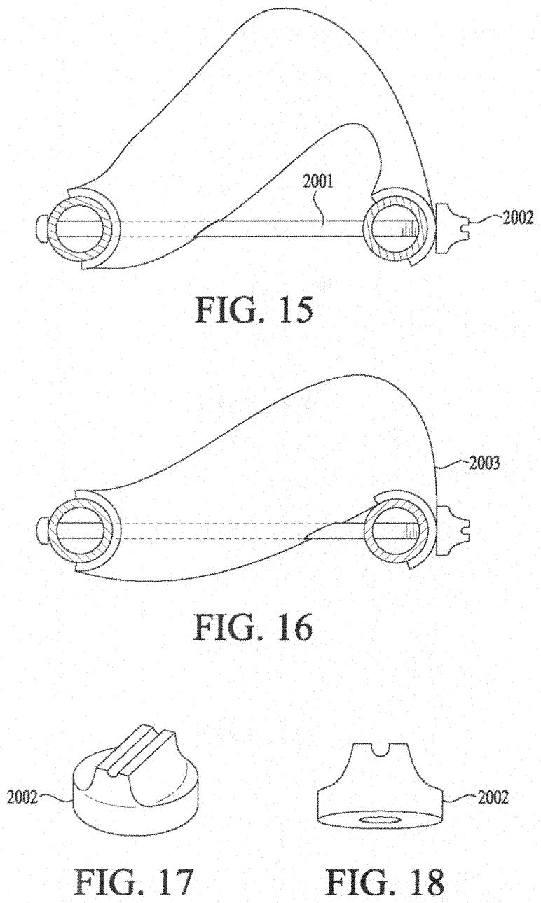

FIG. 15 is a variation of FIG. 16, but the curve of the handle has come out even further out, away from the center or shafts of the crutch. This is for people with different shape/size of hand, but generally, it is very helpful to avoid the damage and pain for the user, similar to the handle shown in FIG. 16, but with different shape, curve, boundary, angle, or extension.

Appendix 3, pages 1-4 and 12, show various parts of the crutch in different embodiments. The first 3 pages are the same crutch in 3 different positions: Each position shows how each segment is moved/slid into the upper telescopic segment, until the bottom and middle segments are completely slid into the top segment, which makes the crutch prepared for use in sitting position. Appendix 3, pages 5-6 and 9-11, show the embodiments for the handle. Appendix 3, page 7, shows the embodiments for the grooved tubes inside each other, e.g., telescopic, pulling out/sliding, for groove, e.g., for pin connection and attachment, to secure the position.

The explanation for Appendix 4, pages 1-5, Sit-Crutch, for a walker:

A walker with vertical holes on the hand bar, which provides our invention/embodiment (Sit-Crutch) bottom support, with insert holes, and affixed to the sit-crutch (collapsed/slide into the top segment or the detached crutch) on the walker.

It is intended to help patients with weakness on both upper body and lower body, and extremities disorders, to experience a safer and more supportive positions, while standing or walking with this walker/crutch integrated system.

Appendix 4, pages 1-2, 4-5, show various components for Sit-Crutch or crutch for various embodiments. Appendix 4, page 3, shows specifically for a walker, which can be combined/exchanged with the components of the crutch invention, mentioned here.

Page 8 in Appendix 3 shows a general suggestion by physicians for a correct/normal hand structure, based on relative position and rotation of fingers and hand/wrist/bone structure in hand/wrist, as shown there in X-ray type/style format, by others. That is why we improved/invented our new/novel crutch handle/grip, to reduce damages, pressure, and stress on hand/wrist/fingers, with proper posture for skeleton/muscles, with no abnormal extension/twist/pressure, with less or no problems for the user/patient.

FIG. 9 shows the solid core that is weight bearing part, which goes through the handle across the upright supports and attached by brackets. The grip will be over-molded on this solid core, as the soft part of the grip.

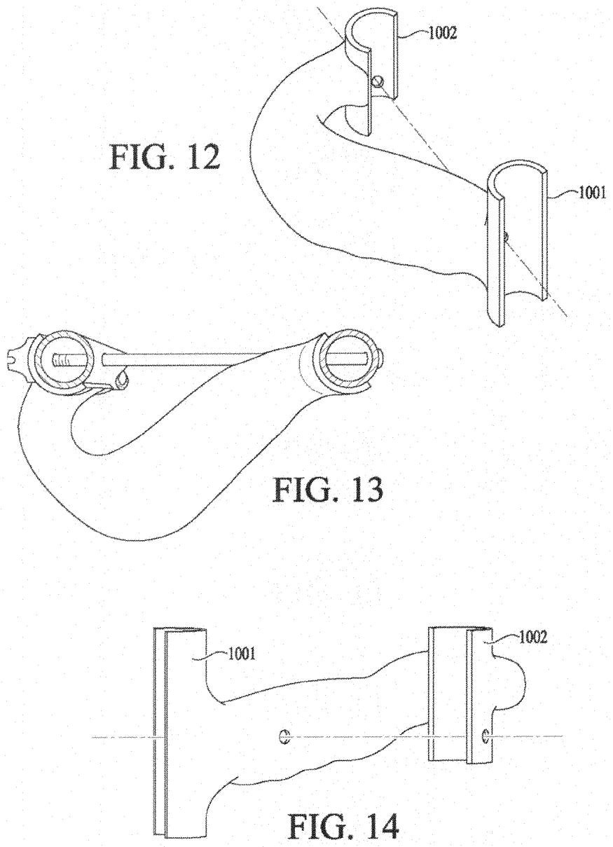

FIG. 12 shows a side view of the handle with larger front bracket (1001) and back bracket (1002), which secure the handle attachment to the upright supports/crutch shafts or bars. FIG. 13 shows the rod through the upright support holes, to fasten handle, by new bolt to the supports. This is a very different handle with respect to the prior art, in which the top view looks like a rectangle with parallel connections to the support poles.

FIG. 14 shows how the rod passes through the handle and both brackets. FIG. 15 shows rod 2001 and bolt 2002. FIG. 16 shows the handle 2003 with attachments and components. It shows a different handle. This handle is designed to be closer to the rod axis with a slight angle to the axis. FIG. 17 shows a bolt 2002 that can be twisted at the end of the rod, either by fingers (thumb and pointing finger), using the curved sides, or by using screw driver, by inserting it into the slot (opening) in the middle.

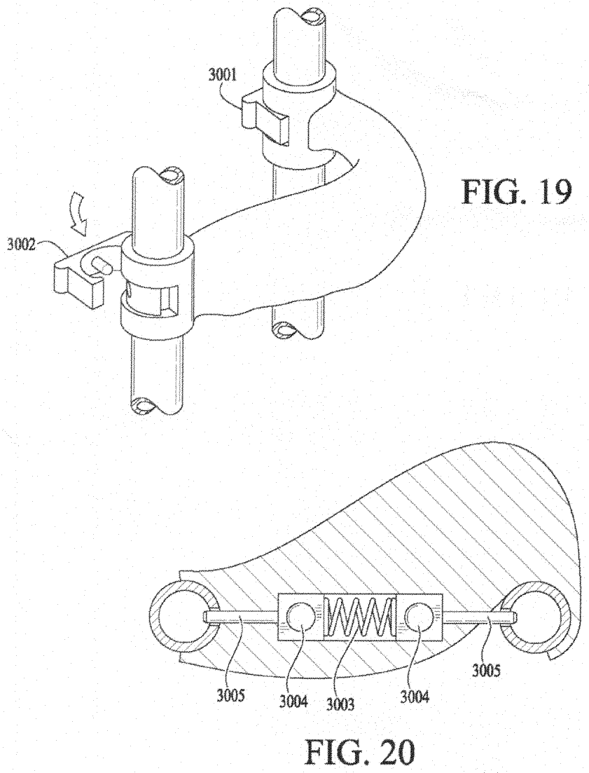

FIG. 18 shows a bolt 2002 that can be twisted at the end of the rod, either by fingers (thumb and point finger), using the curved sides, or by using screw driver, by inserting it into the slot (opening) in the middle. FIG. 19 shows the use of the locks to secure handle on the supports: open 3002 and closed 3001 positions. FIG. 20 shows a new feature/function that uses two concaved tabs (3004) for two-finger placement, that can be pushed together, and as they squeeze the spring (3003), they pull both locking pins (3005) to the center, therefore, releasing the handle system from the upright supports for position adjustment.

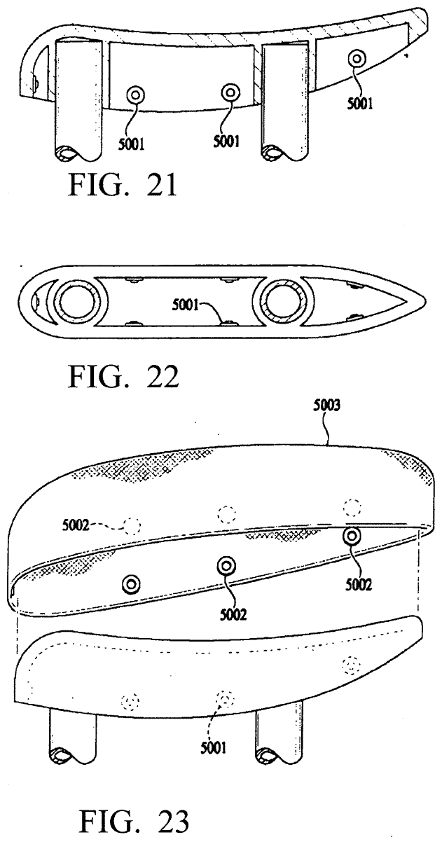

FIG. 21 shows a different form of the underarm cushion, which is moved more to the back of the crutch and is shorter in the front, plus the snap buttons that can be used, instead of rivet (5001). FIG. 22 shows under the underarm structure: the male part of the snap buttons are affixed under the structure. FIG. 23 shows a replaceable/washable cover (5001) plus the female part of the snap button, facing inside of the cover. Female part (5002) of the cover snap on the male part, affixed under the underarm cushion, to secure the washable cover over the cushion (5003).

In one embodiment, we have: A crutch system, said crutch system comprising: multiple vertical bars; wherein said multiple vertical bars are connected together; wherein said multiple vertical bars are adjustable in length and in number, to adjust height of said crutch system for a user; a handle for hand grip; a top section for armpit rest; a bottom section for traction on ground; one or more connectors to connect said multiple vertical bars together; wherein said top section comprises soft elastic material. Other features/features are:

wherein said handle is based on a human hand's skeleton structure for easy hand grip and elimination of wrist injury.

wherein said handle is asymmetric with respect to: the middle of said handle or crutch system or horizontal section or vertical section or connecting bar or supporting middle bar or supporting horizontal bar.

wherein said handle has variable distance to main body of said crutch system.

wherein said handle has a support for pointing finger and thumb of said user's hand.

wherein said handle distributes weight of said user more evenly, to reduce stress on said user's hand, palm of the hand, wrist, and fingers.

wherein said handle has a cross section which is non-rectangular in shape, when viewed from above said crutch system.

wherein said handle has a curvature to fit said user's hand.

wherein said handle has a surface to fit said user's hand.

wherein said handle is angled with respect to said crutch system.

wherein said handle is twisted with respect to said crutch system.

wherein said handle comprises a soft material.

wherein said handle comprises a rigid material.

wherein said handle comprises an elastic material.

wherein said handle comprises a cover or skin.

wherein said handle comprises a cover or shell which is exchangeable.

wherein said handle comprises a cover or shell which is washable.

a spring.

a rough/coarse cover for better grip.

crutch system is convertible to a walker system.

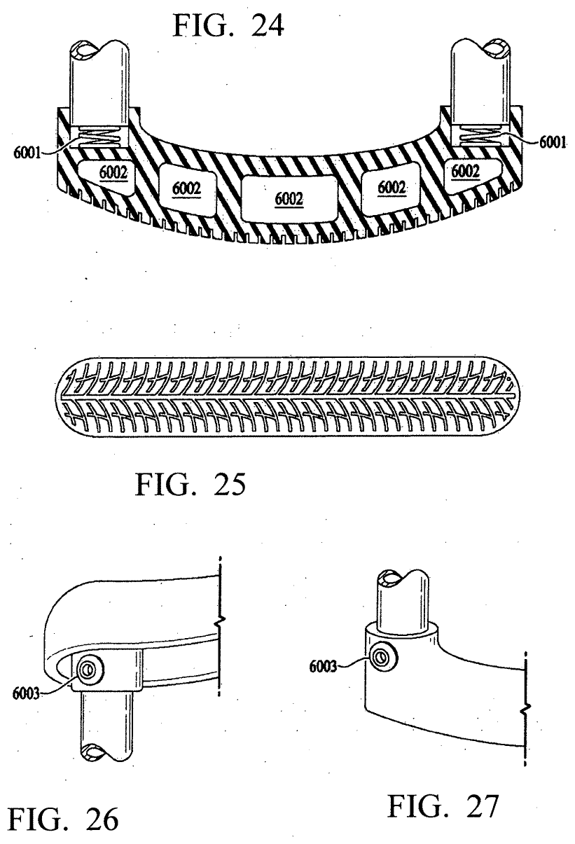

FIG. 24 shows the hollow spaces (6002) that functions as shock absorbent of the base, with spring (6001). FIG. 25 shows the anti-slip/slide thread design, specifically made for the crutch, which has maximum traction power on the ground, to help stabilize the ambulation, especially in case of inclement weather, e.g., with slippery/icy/frosty/mud/sleet ground conditions. FIG. 26 shows the pressed point 6003 that provides secure attachment of the underarm structure and base (from FIG. 27) to the upright supports/pipes/poles.

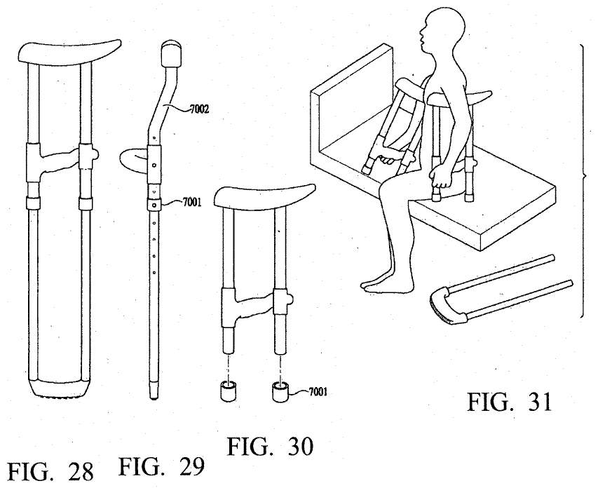

FIG. 27 shows the pressed point that provides secure attachment of the underarm structure (from FIG. 26) and base to the upright supports/pipes/poles. (FIG. 26 is for the underarm, and FIG. 27 is for the base.) FIG. 28 shows a two-part detachable crutch with special ergonomic handle and cushion that sits/positioned toward the rear. FIG. 29 shows a different design that has a curve in top part/segment of the crutch to provide more space between two crutches around the waist area for people with large/wide hip (7002).

FIG. 30 shows two small caps 7001 which can be used after detaching the top part to prevent the bottom end pipes from piercing/denting the sitting surfaces. FIG. 31 shows a totally detachable crutch (with two pieces of top and bottom): top part only in use in sitting position, to stretch the upper body or decompression of back/spine.

Another embodiment: A pair of crutches that is designed for usage in sitting position, in addition to standing and walking positions. This apparatus can adjust to about the one third of the regular height in order to allow the user to use them in sitting position, therefore, it takes most of the upper body weight off the back and lower spine, in which it helps the user with back Injury in sitting position. Each one of the crutches has three segments that telescopically slide into each other, in order to adjust to the height between a supporting sitting surface, such as chair, to the underarm or armpit of the user, while the user is in the sitting position.

This function helps patients with back and spine injury that are having a hard time to sit and encountering lots of pain, as all the upper body weight is bearing on lower injured back, while sitting. This function also creates a traction system in sitting position, as the adjusted crutch pushes up the user's body/torso against the gravity force, therefore, helps to reduce the spine pressure over possible bulge discs and pinching nerves, which cause pain and numbness in body, and also improves postural alignment, while seated. The pair of crutches also have an ergonomic grip that eases the handling process and reduces the pressure on the wrist (and allows/encourages the user to distribute some of the weight on the handles, instead of leaving all the weight on the vulnerable under arm area).

Some of the features are as follows:

A pair of multi-functional crutches comprising of underarm cushions and three body segments which telescopically slide into each other to transform the regular crutch to a sitting crutch for patients who may have difficulty and pain, while sitting, due to the body weight pressure on the injured back and spine. It also has the new ergonomic handle design which helps user to bear most of the user's weight on the palm of her hands, and not on her wrists (e.g., see FIGS. 1, 3, and 7, plus Appendix 1, for more details).

The material and size of the system or apparatus described here can be widely diverse and different, e.g., made of wood, plastic, elastic, rubber, artificial materials, partially wool for cover (or fabric), glass, fiber glass, crystal, metal, alloy, carbon, carbon fiber, polymers, ceramic, transparent materials, translucent materials, glued materials, layered or stacked materials, or the like, and e.g., for sizes from about 0.25 ft as lower end of the range, to 6 ft, as upper range or values, in overall length and height, or from a few mm to a few inches for other dimensions for components and connections/connectors, in the images shown, just as examples. However, these numbers and materials are just examples, and not limiting the invention by any means, in spec or figures or for any purpose.

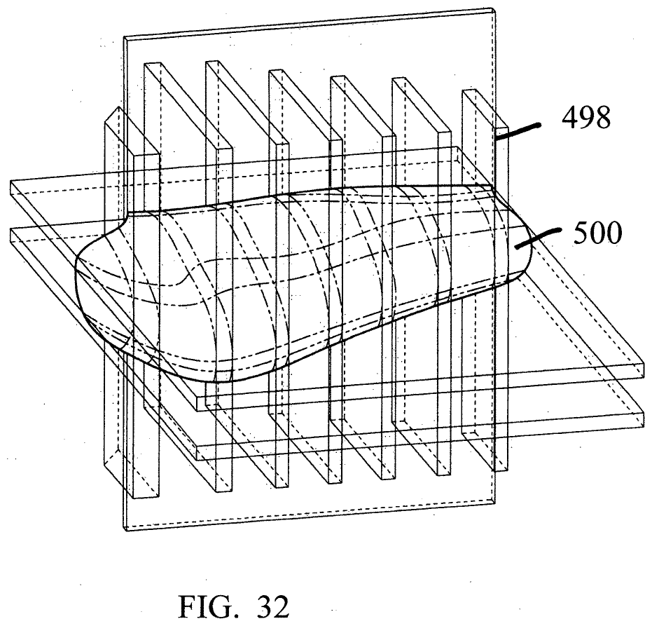

FIGS. 32-37 show a modified handle 500 for a cane or crutch used in various settings. The method of making the handle 500 is also described.

The handle 500 consists of two main parts: an inner ribbed structure and an outer soft covering. The solid, ribbed material in the core of the grip provides a sturdy base for support and enables the overall shape of the grip to extend outward from the crutch. It is composed of high-density acrylonitrile butadiene styrene (ABS), a material known for its toughness and impact resistance. We are the first manufacturer to cut an ergonomic, ribbed shape into such an ABS core. The complexity of the inner structure allows us to adjust its axis and angle to best match the arm and hand's natural posture.

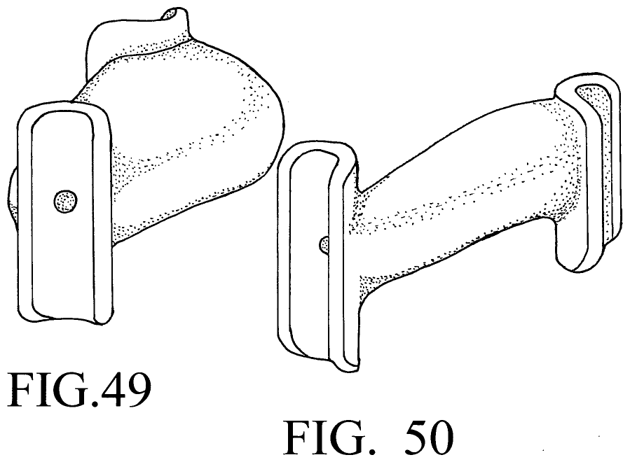

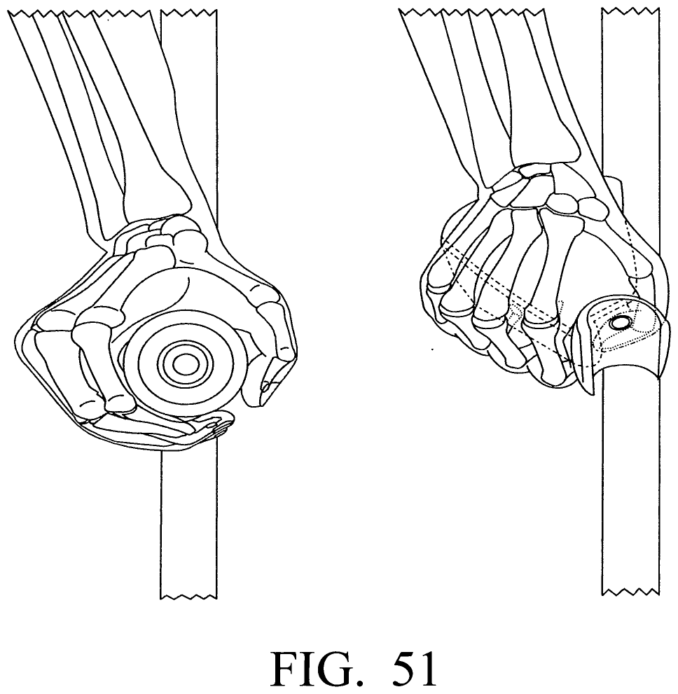

The outer cover (see especially FIG. 49) is composed of textured thermoplastic elastomer (TPE), which is both durable and pliant. Tough but supple, the TPE minimizes pressure to users' fingers. These materials together have enabled us to create a uniquely-shaped handle which is strong and supportive but not hard in the patient's hand. The handle's much larger surface area provides more ergonomic support and a more comfortable hand rest.

The location and angle of our ergonomic grip within the overall crutch structure create two unique aspects which allow better positioning of the hand.

First, unlike conventional crutches, the ergonomic grip (handle 500) sits outside of the plane of the rest of the crutch. This location prevents the patient from twisting their hand and wrist inward and their elbow outward in order to hang onto the crutch.

Second, the handle itself is set with a slight downward slope from back to front, akin to the natural angle of a person's first as it rests by their side. This keeps the patient from twisting their hand and wrist upward as they hold the crutch.

Overall, Ergo Grip™ (500) is positioned so that the patient's hand and arm sit in a natural position as they hold the crutch.

Supportive Hand Rest

The shape of Ergo Grip™ (500) was designed to perfectly fit the shape of the hand. The molded fit allows the hand to maintain a natural shape when holding on to the handle, with even points of contact across the palm and all fingers. A flat, broad surface creates a wide plane for pressure distribution that does not put excess pressure on any one point in the hand (see FIG. 3). The longer handle also avoids hand and finger cramping and slipping that occurs with smaller, shorter handles that come with standard crutches. Softer material also helps to cushion the weight that is applied.

We developed the shape of the hand rest by using molding material to form into the shape of the inside grip of the hand. This was scanned into a digital image to allow this shape to be perfectly replicated.

FIG. 32 shows a mold apparatus exemplifying the method of forming a mold 498 and the subsequent crutch handle 500 produced thereby. The shape of the mold 498 is determined by creating, on a user by user basis preferably, an impression formed of a compressible molding material grasped by the intended user. A scan of the molding material formed by the user's hand impression is then taken and the digital results are used to create the crutch handle 500. This is done for both the user's right and left hands.

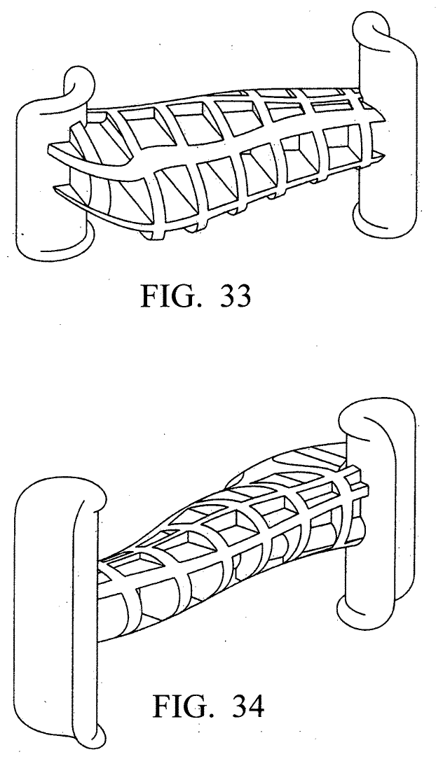

FIG. 33 shows the structure of the new ergonomic handle 500 with special brackets 502 attached to the structure as one embodiment. The structure (500) between the two brackets is specifically designed to support the ergonomic shape of the ergonomic grip designed by ND Products Inc. This new method helps with design challenges of proper and even ergonomic surface weight bearing support and shifting the weight bearing surface from main rod support in standard Grips to outside of the rod support axis without loosing the sufficient support needed in shifted weight bearing area. FIG. 34 is the same as FIG. 33 from a different angle.

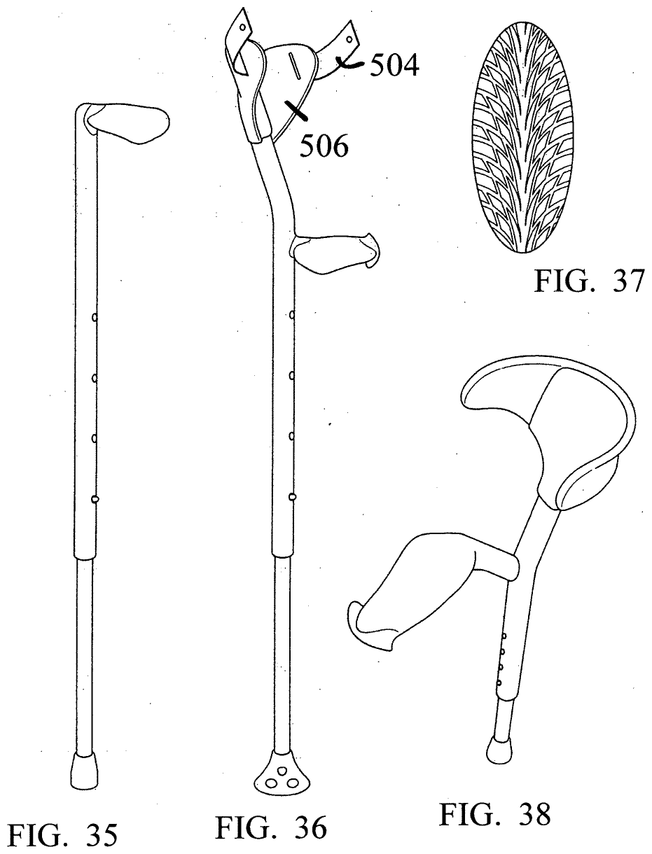

FIG. 35 shows a cane designed with Ergo Grip handle (500). The upright support can be made from any material and color. Changeable tips; the tip (bottom elastic part) Can be changed to any type and size available in the market including ND products tips in FIG. 36. The height of the cane is adjustable.

FIG. 36: A forearm crutch designed with Ergo Grip™ handle. Featuring two bands/strap 504 adjacent to each side of the cuff 506, in which can wrap around the user's arm while placed in the cuff and come together in the front and connect by any means such as buttons or Velcro or other attachment to secure the forearm crutch to the arm of the user. Also in user need to free their hand and let go of the grip such as opening a door, the strap will hold the crutch to their arm and prevent from falling onto the ground or need of fetching the crutch again.

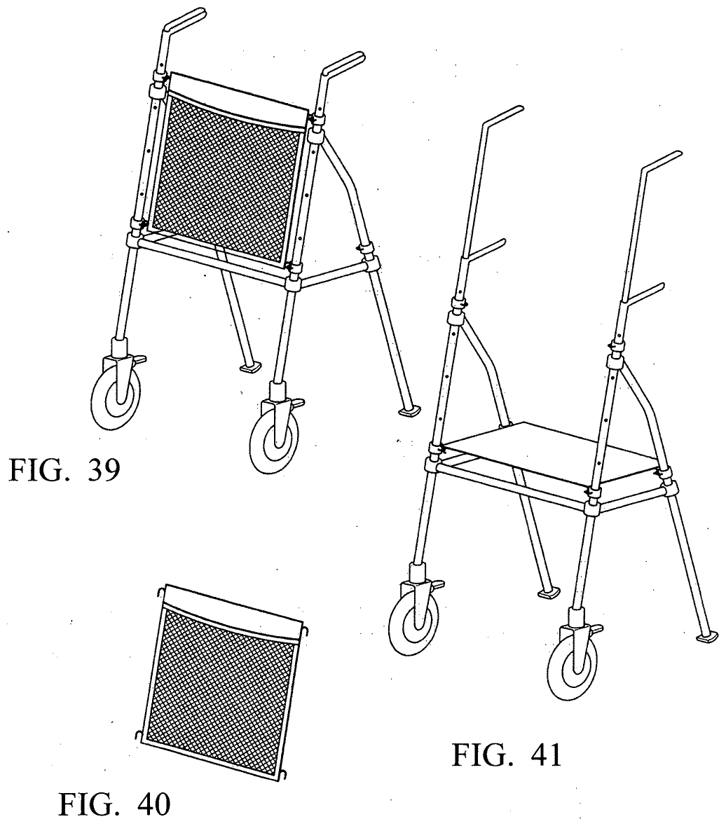

The New tip in FIG. 38 can be used on both forearm crutches or canes. This design is a smaller Version of our previous patent (US 2018/0133093 A1/see FIG. 26 and FIG. 27) which is herein incorporated by reference.

The difference is the shock-absorbing capsules/openings inside of previous patent that was large and for two upright support as oppose to this tip in which it is smaller to fit the smaller tip to fit one upright support in order to fit a cane or forearm crutches with one upright support. The shape and size of the capsules and openings may vary in this design. This enhances the comfort and reduces long term hand, arm and shoulder damage.

FIG. 37 shows a tread pattern for the cane or crutch tip which allows for greater traction on slippery surfaces.

FIG. 38 shows a different forearm crutch design where there is a horizontal support with A diagonal axis coming out of the upright support and bearing to the right. The end of the Said horizontal support is adjacent to the Ergo Grip™. The grip is then bearing to the right. This new design helps with positioning the user's hand according to the natural human hand position to prevent strains and damages on carpal and other parts of the hand and arm.

Referring now to FIGS. 39-45 a first embodiment of a multifunctional crutch apparatus (520) is shown. The apparatus 520 replaces the front support and handle of a walker 522. In the position (closed position) shown in FIG. 39 it provides additional height to the handle of the walker 522 to prevent the user from slouching that happens with standard walkers, and keep the body straight during ambulation to prevent other side effects of unnatural position and strains on shoulders, arm and spines. This FIG. 39) also shows a multipurpose pouch with rectangular solid frame and 4 hooks close to each corner (FIG. 40). The hooks are adjacent into the small hoops on each of 4 clips secured on the walker supports. This position secures the pouch vertically in order to place any belonging into the pouch to keep them handy for the user during the use of the walker.

FIG. 40 shows the multifunctional pouch/seat. The pouch could include one or more pockets to support and hold items such as phone, wallet, pen, pad, etc. when is installed in vertical position. This pouch can be used as a seat of the walker when unhooked from the two top hoops and Then hooked to the two hoops in the back supports. Once this change is done the pouch can Function as a seat for the user to take a sit on it and rest as needed.

FIG. 41 shows the two parts crutch as the front upright of the walker in opened position. In this position the use can take advantage of the second function in which is a combination of handle for a hand grip and a under arm crutch to alleviate the user weight pressure and strains over The shoulders, arms, wrist, hand and spine. This function turns two points support of two hand grips seen on a standard walker to four point support consisting of two hand grip supports and two underarm supports at the same time. Therefor prevent excessive pressure on user during ambulation with doubling the conventional supports. The small lever in front wheels can lock the wheel so it prevents the walker from moving as needed. For example when user need to use the sit in the walker.

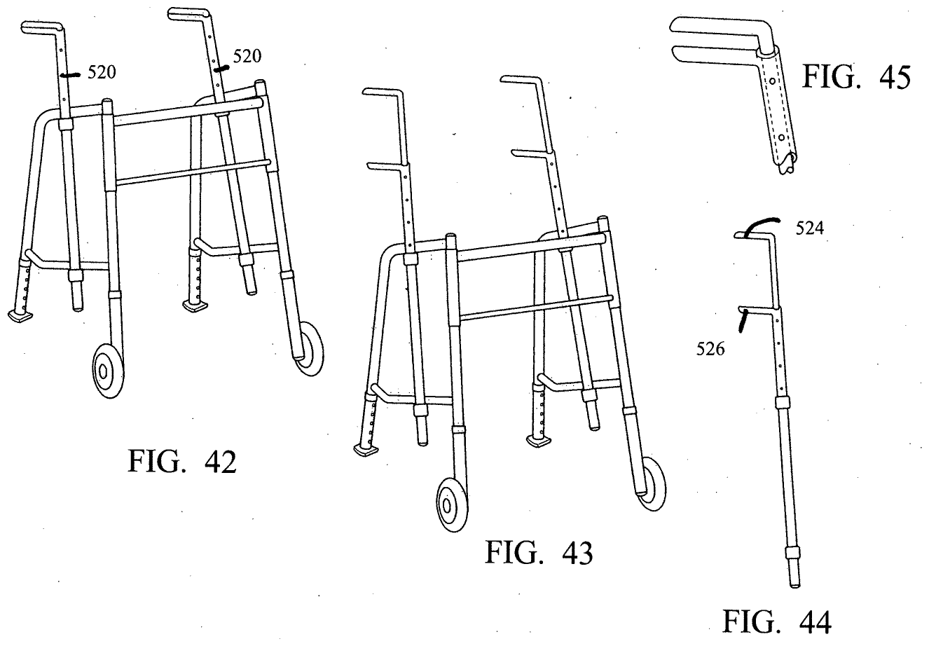

FIG. 42 is an example of conventional walker in which has two multifunctional (handle, cane, crutch) adjacent to right and left sides which turns a conventional walker to Multifunctional one. This design has many advantages including;

a) Adjustable height for the walker handle to prevent slouching.

b) Can be detached from the crutch to be used as a cane

c) Can be opened as shown in FIG. 45 to provide handles and underarm crutch with 4 points of body support.

FIG. 43 shows the open position of multifunctional parts (520) that provides 2 point of hand grip support for right and left hand in addition to extra 2 points support of underarm crutch.

FIG. 44 shows the multifunctional ambulation device by itself in open position in which is this position can be used as a crutch. However when closed can be used as cane, or when is installed on a walker can be used as an adjustable handle.

FIG. 45 showing a detail of the two parts of the multifunctional device that is consist of a main body functioning a main upright support that is adjacent to lower half of the handle, and the Core support in which can move and adjust inside of the main support telescopically, that is adjacent to the upper half of the handle when the core support is pulled out of the body the adjacent top half of the handle separates form the bottom half Once the top part is completely pulled out in which shown in FIG. 44, the top 524 of the handle can be placed under arm as an underarm support while the bottom part of the handle 526 stays in the same place and can be used as a handle or grip.

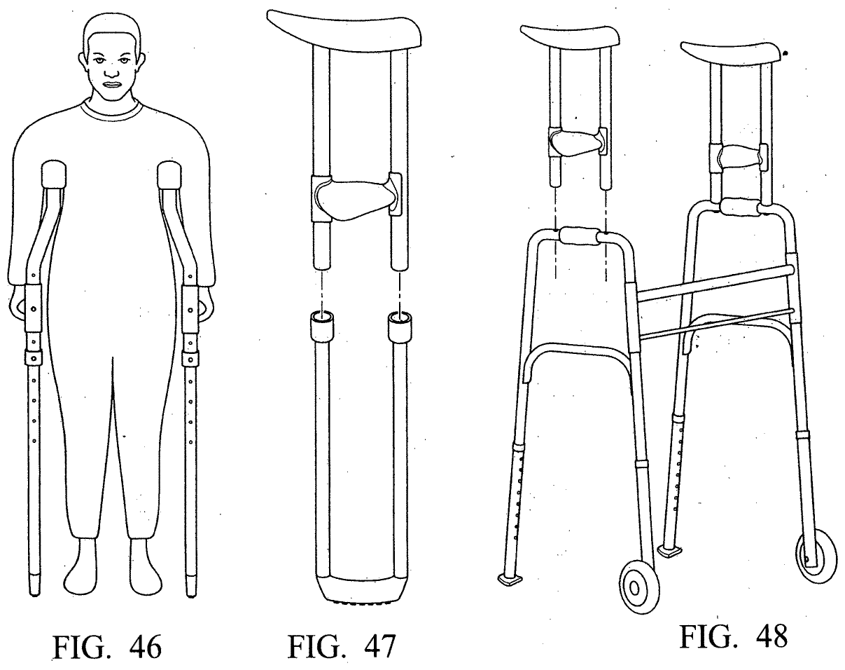

FIG. 46 shows the same curved crutch in our previous application (FIG. 31 US 2018/0133093 A1) that is designed for obese or people with larger hip to prevent unsafe angles of crutch positioning to the ground. This will allow the user with abnormal body form to keep the crutch close to the body and perpendicular to the ground therefor creating a vertical touch to the ground in which prevents slip of the crutch to the sides and provides more secure ambulation. This crutch also can be designed and produced With different curvature to accommodate the different hip size or specific body shape of a person.

FIG. 47 showing the same crutch in our previous patent (FIGS. 32 and 33) That can be Separated but this time instead of using the top part of the crutch as sit-crutch for back decompression in sitting position, the top part of the crutch is installed on a walker, in order to create 4 points of support; 2 handle and 2 underarm supports for the user (also mentioned in previous patent appendix).

The combination of our sit-crutch and a walker provides variety of durable medical devices For the users including but not limited to;
a) More comfortable and safer crutch with two upright support perpendicular to the ground with special large tip (previous patent FIG. 1,2,3)
b) Sit-Crutch: the first crutch for sitting position to decompress the spine and lower back muscles (previous patent FIG. 4)
c) Four point of supports for both left and right hand grips and underarms when installed on a walker.
d) Safer ambulation in inclement weather such as slippery and uneven ground conditions.
e) More comfortable arm, hand and wrist position due to the special ergonomic grip that supports the hand in the natural position without excessive strains seen in conventional grips.

FIG. 48 shows the top part of the Sit-crutch separated and installed on a walker in order to create 4 points of support; 2 handle and 2 underarm supports for the user. (also mentioned in previous patent appendix).

FIGS. 49 and 50 Showing the Ergo Grip (handle 500) after a flexible and cushion overmold that can be made of gel or TPE or any other elastic or cushion material is installed on it to create the utmost comfort by providing a natural position for human hand while using any kind

Of durable medical device application including the some explained in this patent.

It provides much larger horizontal support comparing available crutch handles that is perfectly Secured to both upright supports of an underarm crutch by its front and back brackets.

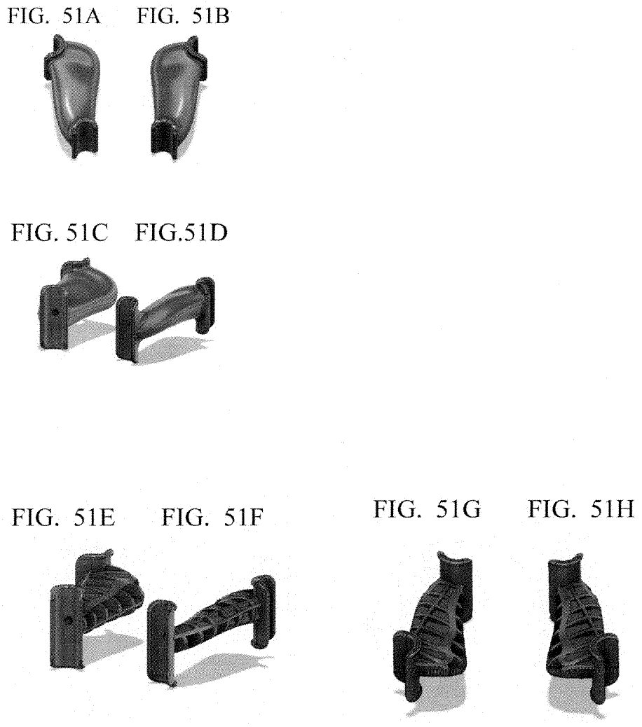

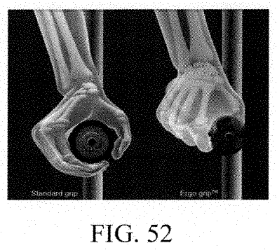

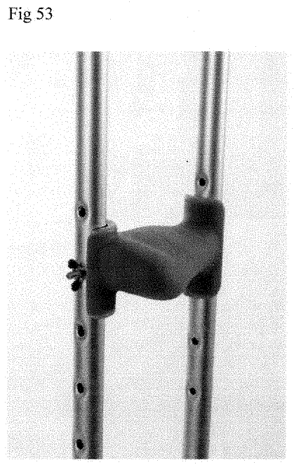

FIGS. 51A-51H show the handle 500 from various angles and at various stages of manufacture. Both the inner core and outer cover are shown. FIG. 52 shows a comparison of the stresses on the user's hand of the handle 500 of the invention versus a conventional handle on the right side of the illustration. Stresses are highlighted by shading, so it can be seen that the conventional grip produces more stress than the handle 500 of the invention because of the angling and contouring of the handle 500 as explained in detail above. Finally, FIG. 53 shows the handle 500 positioned on a standard crutch.

Any variations and any combinations of the above teachings are also intended to be covered by this patent application.

1-5. (canceled)

6. A hand grip for a crutch system, said crutch system including at least front and rear vertical support poles extending downwardly to ground from an armpit rest, said front and rear poles positioned within a single vertical plane, the hand grip comprising:
opposing end portions, a first end portion connected to said front support pole and a second end portion connected to said rear support pole, said hand grip having a curved profile so that a portion of said hand grip lies outside of the plane of said front and rear support poles.

7. The hand grip of claim 6 wherein the curved profile is adjusted in curvature in response to measurement from a user.

8. The hand grip of claim 6 wherein said lower vertical height is in the range of 0 to 3 inches.

9. The hand grip of claim 6 wherein said hand grip has a front portion and a rear portion,
said front portion terminating at said first end portion and said rear portion terminating at said second end portion;
said front and rear portions both extending angularly outwardly from said vertical plane to form said curved profile.

10. The hand grip of claim 6 wherein said hand grip has a central portion positioned between said front and rear portions, said central portion offset relative to a central point between said front and rear support poles.

11. The hand grip of claim 6 wherein said hand grip has a non-rectangular cross section.

12. The hand grip of claim 6 wherein a top surface of said hand grip is sufficiently wide to accommodate a user's thumb and forefinger.

13. The hand grip of claim 6 wherein said hand grip is made of dissimilar materials.

14. The hand grip of claim 13 wherein one of said materials is hard relative to the other.

15. The hand grip of claim 6 wherein said hand grip has an outer cover that is washable.

16. A method of making a hand grip for a crutch system comprising the steps of:
using a compressible material to form an outline of a user's hand impression and then scanning and digitizing the outline to create a digitized outline;
creating a solid ribbed core structure based on said digitized outline;
overmolding a cover onto said ribbed core structure; and,
covering said cover with a pliable material.

17. The method of claim 16 wherein said core is formed of an ABS material.

18. The method of claim 16 wherein said cover is formed of a TPE material.

19. A hand grip for a crutch system, said crutch system including at least front and rear vertical support poles extending downwardly to ground from an armpit rest, said front and rear poles positioned within a single vertical plane, the hand grip comprising:
an elongated main body with opposing end portions, a first end portion connected to said front support pole and a second end portion connected to said rear support pole, said first end portion terminating in a first mounting bracket and said second end portion terminating in a second mounting bracket,
both of said mounting brackets having concave engaging surfaces for receiving and engaging said poles, said concave engaging surfaces vertically oriented so as to have vertical axes;
said mounting brackets and said main body formed of a unitary single piece construction;
where said first mounting bracket is rotated up to 90 degrees relative to said second mounting bracket about said vertical axes.

20. The hand grip of claim 19 wherein said hand grip has an inner ribbed core and an outer covering.

21. The hand grip of claim 20 wherein said outer covering is covered with a gel material.

22. The hand grip of claim 20 where said inner ribbed core is formed of a harder material than said outer covering.

23. The method of claim 20 wherein said inner ribbed core is formed of an ABS material.

24. The method of claim 20 wherein said inner ribbed core is formed of a solid material.

25. The method of claim 20 wherein said inner ribbed core is formed of a harder material than said outer covering.

26. A cane comprising:
an elongated main body having a top end and a bottom end;
a hand grip attached to and extending from said main body in a generally perpendicular direction, said hand grip formed in accordance with digitized measurements of a user's hand, said hand grip having a solid inner ribbed core and an outer covering.

27. The cane of claim 26 wherein said inner core is made of a harder material than said outer covering.

28. The cane of claim 26 wherein said outer covering is molded onto said inner core to produce a hand grip of unitary construction.

29. The cane of claim 26 wherein said core is formed of an ABS material.

30. The cane of claim 26 wherein said core is formed of a solid material.

31. A forearm crutch comprising:
a vertical elongate support, having a lower end adapted for contact with a walking surface, and an upper end in mechanical communication with a forearm support, said upper end angled relative to said lower end;
said forearm support having a forearm cuff attached thereto;
a hand grip attached to and extending from the elongate support by a connecting rod in a generally perpendicular direction, said hand grip formed in accordance with digitized measurements of a user's hand, said hand grip having a solid inner ribbed core and an outer covering.

32. The forearm crutch of claim 31 wherein said inner core is made of a harder material than said outer covering.

33. The forearm crutch of claim 31 wherein said outer covering is molded onto said inner core to produce a hand grip of unitary construction.

34. The forearm crutch of claim 31 wherein said core is formed of an ABS material.

35. The forearm crutch of claim 31 wherein said cover is formed of a TPE material.

36. The forearm crutch of claim 31 wherein said forearm cuff is made of a pliable material and has an opposing pair of straps extending therefrom.
